(19) United States
(12) Patent Application Publication
(10) Pub. No.: US 2009/0309285 A1
(43) Pub. Date: Dec. 17, 2009

(54) Device for holding disk-shaped objects

(75) Inventors: Rene Schenck, Jena (DE); Thomas Iffland, Jena (DE); Winfried Deutscher, Jena (DE)

Correspondence Address: Davidson, Davidson & Kappel, LLC, 485 7th Avenue, 14th Floor, New York, NY, 10018, US

(73) Assignee: VISTEC Semiconductor Systems Jena GmbH, Jena (DE)

(21) Appl. No.: 12/455,634

(22) Filed: Jun. 4, 2009

(30) Foreign Application Priority Data
Jun. 11, 2008 (DE) DE 102008027861.0

(51) Int. Cl. B23Q 3/00

(52) U.S. Cl. 269/289 R

(57) ABSTRACT

A device for holding disk-shaped objects, particularly semiconductor wafers, having at least three contact elements for depositing and/or fixing the disk-shaped object at its outer edge area. The contact elements are designed such that they have an incline facing the object and a supporting surface.

This claims the benefits of German Patent Application No. 10 2008 027 861.0, filed on Jun. 11, 2008 and hereby incorporated by reference herein.

The present invention relates to a device for holding disk-shaped objects. Preferably semiconductor wafers deposited on and fixed with the device.

### BACKGROUND

For the industrial production of chips for the semiconductor industry, integrated circuits are produced on disk-shaped carriers in several consecutive steps. As part of this production process, it is necessary that each disk-shaped carrier, hereinafter also called wafer, is transported from one processing station to another processing station or to an inspecting station. Usually this is done by using a so-called robotic arm, which singulates the wafer from a stack and, for example, supplies it to a means for inspecting the wafer. Such a handling system for wafers with associated robotic arm is known, for example, from US 2003/0031537 A1. The handling system described therein also comprises a robotic arm, which helps to transfer the wafers from a loading station to an inspecting station, wherein a holding means for holding the wafer is provided in the inspecting station.

When the wafer is transferred to the holding means, it is important to ensure that it is centered as best as possible and that it does not fall out when it is deposited in the holding means.

Various holding means are already known in this context. For example, U.S. Pat. No. 7,227,628 suggests that, for inspecting the backside of a wafer, the wafer is deposited on a carrier having three support elements. The means for inspecting the wafer is designed as a module.

For further improvement of the handling, DE 10 2007 010 223 A1 suggests a method for determining geometric parameters of a wafer. The wafer is inserted into a holder having at least three mechanical contacting elements on which the wafer is positioned. The contacting elements are distributed on the holder such that they define a geometric figure which is configured such that the center point of the wafer comes to lie within the geometric figure. The position of each contacting element is determined. Then the desired geometric parameter of the wafer is calculated from the position of the contacting elements.

### SUMMARY OF THE INVENTION

It is an object of the present invention to provide a device for holding disk-shaped objects improving the holding reliability and the protection of the disk-shaped object against damage irrespective of the design of the object's edge.

The present invention provides a device for holding semiconductor wafers, comprising at least three contact elements for depositing and fixing the semiconductor wafer at its outer edge area, and an incline facing the semiconductor wafer and a supporting surface for the semiconductor wafer are formed at the contact elements.

The present invention as well provides a contact element for holding a semiconductor wafer has a essential cylindrical form, an incline across the cylinder and a supporting surface at the bottom of the cylinder for receiving the semiconductor wafer.

Accordingly, the present invention suggests a device for holding disk-shaped objects, particularly semiconductor wafers, having at least three contact elements for depositing and/or fixing the disk-shaped object at its outer edge area. The contact elements comprise an incline facing the object (semiconductor wafer) and a supporting surface. With an incline and a supporting surface provided, an object to be inserted into the holder may slide along the incline to the supporting surface so that even objects inserted at an angle will be securely guided to and held in the desired position. The semiconductor wafers come to rest on the supporting surfaces.

A frequent application of such devices is the implementation as wafer receiving plate, which may be used for receiving and holding a wafer above a scanner. In order to keep the backside of the wafer nearly completely free for the scanner, the supporting surfaces on which the wafer is deposited should cover the edge area only minimally. For this reason, the contact elements of the inventive device are kept as small as possible.

In order to ensure a maximally reliable sliding of the object during insertion into the receiving plate, the incline may be chosen to form an angle essentially between 40° and 10° with respect to the normal of the supporting surface. An angle between 30° and 15°, and particularly an angle of 30° or 15°, has proven to be particularly useful.

The supporting surface can be positioned at the lower end of the incline and may, for example, be designed as a continuous surface. It is also possible to implement the supporting surface as a discontinuous surface, for example in the form of a grid. The supporting length of the supporting surface is preferably between 2 mm and 6 mm, wherein supporting lengths of 3 mm for the fixedly arranged contact elements and of 5 mm for the movably arranged contact elements have proven to be particularly advantageous for securely depositing the object. In a further embodiment of the invention, a particularly secure support may be ensured by choosing essentially 5 mm as the supporting length of all contact elements.

In a further embodiment of the invention, the contact elements may be arranged at an angle of 120° with respect to each other, wherein two of the contact elements are arranged fixedly and one of the contact elements is arranged to be movable for clamping the object. In that way, tolerances in the outer dimensions of the object may be compensated so that the objects may also be clamped and held with light pressure. It is particularly advantageous if the two fixedly arranged contact elements are arranged in the inlet area of the object, because this ensures that the inlet area of the object is limited.

The present invention also provides a contact element for holding an object, particularly a semiconductor wafer, wherein the contact element is designed to be essentially cylindrical and comprises an incline across the cylinder and a supporting surface at the bottom of the cylinder for depositing the object.

The suggested contact element and the suggested device for holding a disk-shaped object advantageously allow the desired securer support and the insertion of the object in a defined position.

### BRIEF DESCRIPTION OF THE DRAWINGS

Further advantages and advantageous embodiments of the invention will be discussed in the following drawings and the associated parts of the description, wherein:

FIG. 1 schematically illustrates a handling means for handling wafers by means of a robotic arm;

FIG. 2 schematically illustrates a device for holding a semiconductor wafer;

FIG. 3 shows a perspective view of an inventive contact element;

FIG. 4 shows a cross-section of an inventive contact element; and

FIG. 5 shows a top view of an inventive contact element.

Throughout the drawings, identical reference numerals refer to elements or functional groups that are identical or have essentially the same function.

### DETAILED DESCRIPTION

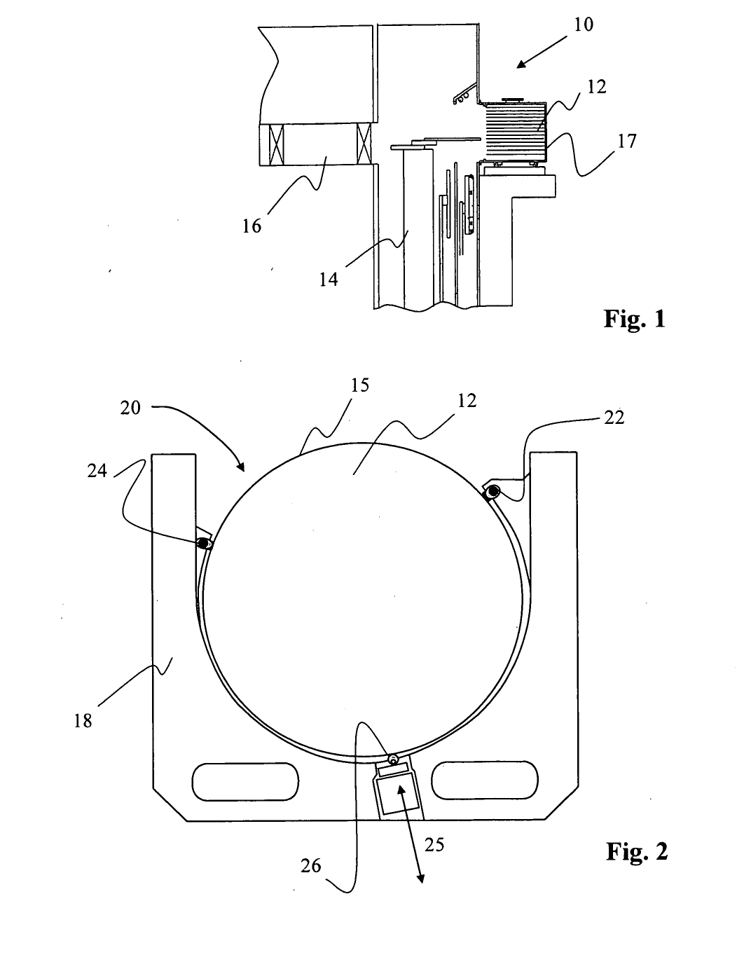

FIG. 1 schematically illustrates a handling means or handler 10 for handling wafers 12 by means of a robotic arm 14. A plurality of wafers 12 is accommodated in a loading station 17. A single wafer 12 is removed therefrom by means of the robotic arm 14 and is transferred to a processing or inspecting station 16. In the processing or inspecting station 16, the wafer 12 is usually held in a holding means 18 (FIG. 2).

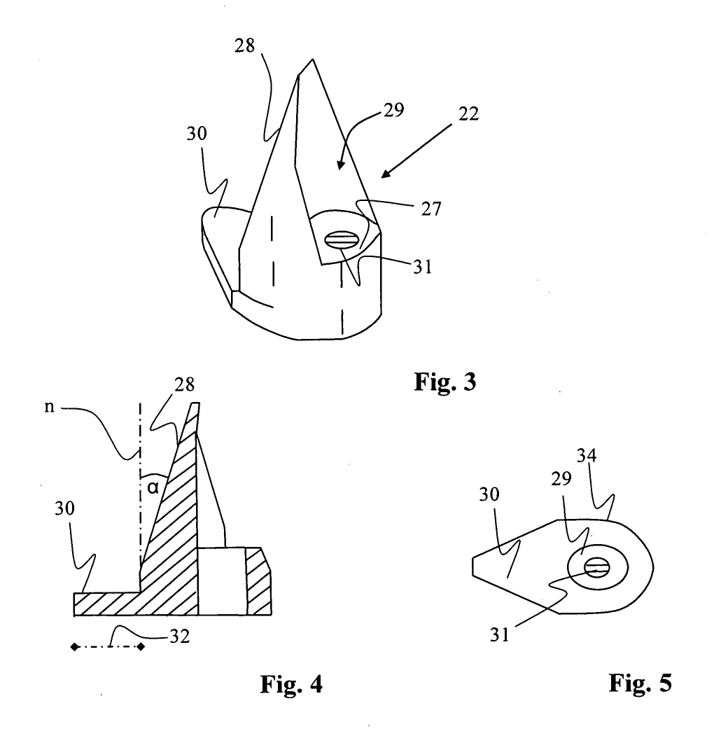

The schematic illustration of FIG. 2 illustrates an embodiment of an inventive device for holding a disk-shaped object by way of the example of a semiconductor wafer 12. For determining the center point or other geometric parameters of a wafer 12 or for other handling steps, the wafer 12 is inserted in the holding means 18. The holding means 18 comprises an essentially circular opening 20, which is designed to be slightly larger than the wafer 12 itself. The holding means 18 is provided with three contact elements 22, 24, 26. The wafer 12 is inserted into the opening 20 of the holding means 18 by the robotic arm 14 and, after insertion, is positioned on the supporting surfaces 30 (cf. FIG. 3) of the contact elements 22, 24, 26. In order to facilitate bringing the edge 15 of the wafer 12 into mechanical contact with the contact elements 22, 24, 26, at least one contact element 26 may be designed to be movable. The movable contact element 26 may be moved along a direction of movement 25. By means of the movable contact element 26, the edge 15 of the wafer 12 is brought into contact with the remaining non-movable contact elements 22, 24.

In order to facilitate the insertion of the wafer 12 and to make it more secure and precise, the contact elements 22, 24, 26 have a special shape. This shape is mainly characterized by two components, i.e. an incline 28 and a supporting surface 30. FIG. 3 is a perspective view schematically and exemplarily showing a contact element 22, such as it may be used both for the movable contact element 26 and the non-movable contact elements 22, 24. With the help of the specially designed contact elements 22, the insertion of a wafer 12 may be performed in a more secure and precise way. A wafer 12 inserted into the holding means 18 may slide down the inclines 28 of the contact elements 22, 24, 26 until it is securely positioned on the supporting surfaces 30, irrespective of its position in the robotic arm 14. Particularly if the loading is performed by means of so-called asymmetric end effectors, the result is often that the center of gravity of the wafer 12 gets very close to the connecting line between the ends of the end effectors. When the wafer is inserted into the holding means 18, the inclines 28 provided on the contact elements 22, 24, 26 may prevent the wafer 12 from being lifted and from slipping through between the two contact elements 22 and 26. Instead, the design of the contact elements 22, 24, 26 including an incline 28 and a supporting surface 30 ensures that the incoming wafer 12 will slide along the incline 28 as desired and will come to rest safely on the supporting surface 30. In combination with the movable contact element 26, this then allows clamping the wafer 12 in a simple way in its edge area, as described above. As shown in FIG. 3, the contact element 22 may be designed to be essentially cylindrical, wherein the incline 28 is incorporated in one of the cylinder surfaces. In the holding means 18, the contact element 22, 24, 26 is positioned such that the incline 28 is oriented towards the wafer 12 to be inserted. For fixation, the contact element 22 may comprise a cavity 29 in its cylinder volume, wherein a means for fastening the contact element 22, particularly a screw 31, may be provided on the bottom 27 thereof. For example, a plastic injection molding method using a suitable plastic may be used for the production of the contact elements 22, 24, 26.

FIG. 4 shows a cross-section of an exemplary contact element 22. As shown, the incline 28 is arranged to be at an angle a with respect to the normal n on the surface of the supporting surface 30. The angle a preferably has a value essentially between 40° and 10°. The wafer 12 slides particularly well into the supporting surface 30 if the angle a is in the range between 30° and 15° (including the limits of the interval). In practice, particularly good results were achieved when choosing an angle a of 30° or 15°. The supporting length 32 of the supporting surface 30 is selected such that the wafer 12 may be securely supported. However, it must also be taken into account that a minimum of the surface of the wafer 12 should be covered in the supported areas. Therefore a supporting length 32 between 2 mm and 6 mm has proven to be useful for all contact elements 22, 24, 26. Good results could be achieved by choosing essentially 3 mm as the supporting length 32 of the supporting surfaces 30 of the fixedly arranged contact elements 22, 24, and 5 mm as the supporting length 32 of the supporting surface 30 of the movably arranged contact element 26. For particularly secure support, the supporting length 32 may be chosen to be 5 mm for all contact elements 22, 24, 26. The supporting surface 30 itself may be implemented as a continuous surface or as a discontinuous surface, such as line or polygon grids.

FIG. 5 shows a top view of an inventive contact element 22, 24, 26. An essentially cylindrical body 34 extends upwards with the supporting length 32 adjacent to the bottom thereof. There may also be seen the bottom 27 of the cavity 29, where there is provided a fastening means, such as screw 31.

The invention has been described with reference to particular embodiments. However, someone skilled in the art will appreciate that modifications and changes may be made to the invention without departing from the scope of the following claims.

What is claimed is:

1. A device for holding semiconductor wafers, comprising:
at least three contact elements for depositing and fixing the semiconductor wafer at its outer edge area, an incline facing the semiconductor wafer and a supporting surface for the semiconductor wafer being formed at the contact elements.

2. The device of claim 1, wherein the incline extends at an angle between 40° and 10°, with respect to a normal (n) of the supporting surface.

3. The device of claim 2, wherein the incline forms an angle (α) of 30° with respect to the normal (n) of the supporting surface.

4. The device of claim 2, wherein the incline forms an angle (α) of 15° with respect to the normal (n) of the supporting surface.

5. The device of claim 1, wherein the supporting surface is designed as a continuous surface.

6. The device of claim 1, wherein the supporting surface is designed as a discontinuous surface.

7. The device of claim 6, wherein the discontinuous surface is a grid.

8. The device of claim 1, wherein the three contact elements are arranged at an angle of 120° with respect to each other, and that two of the contact elements are arranged fixedly, and that one of the contact elements is arranged to be movable for clamping the object.

9. The device of claim 8, wherein the two fixedly arranged contact elements are arranged in an inlet area of the semiconductor wafer.

10. The device of claim 1, wherein a supporting length of the supporting surface of the contact elements is between 2 and 6 mm.

11. The device of claim 10, wherein the supporting length of the supporting surfaces of the fixedly arranged contact elements is 3 mm and that the supporting length of the supporting surface of the movably arranged contact element is 5 mm.

12. The device of claim 10, wherein the supporting length of the supporting surfaces of all contact elements is equal.

13. The device as recited in claim 12, wherein the supporting length is 5 mm.

14. A contact element for holding a semiconductor wafer comprising: a cylinder, an incline across the cylinder and a supporting surface at the bottom of the cylinder for receiving the semiconductor wafer.
